(19) United States
(12) Patent Application Publication
(10) Pub. No.: US 2006/0069902 A1
(43) Pub. Date: Mar. 30, 2006

(54) Method for recovering operating system and user data executed in a computer and its recovery system thereof

(76) Inventors: Yu Rui, Shanhai (CN); Xiaohua Gung, Shanhai (CN); Huiqin Yang, Shanhai (CN); Junfeng Fan, Shanhai (CN); Xiaohong Xiao, Shanhai (CN); Lian-Jen Tian, Shanhai (CN)

Correspondence Address: G. LINK CO., LTD.;Suite 137, 931 West 75th Street, PmB 174, Naperville, IL, 60565, US

(21) Appl. No.: 10/952,758

(22) Filed: Sep. 30, 2004

(51) Int. Cl. G06F 15/177

(52) U.S. Cl. 713/1

(57) ABSTRACT

This invention discloses a recovery method comprising the step of (a) preparing an optical disc which comprises a small operating system, a recovery utility program, and recovered computer operating system/application program/user data; (b) starting the optical disc to run the small operating system and the recovery utility program in the computer, creating a recovery partition on a local hard disk drive of the computer after the execution, formatting the recovery partition, copying the small operating system, recovery utility program, pre-compressed operating system/application program/user data to the recovery partition, and setting the recovery partition as the booting partition; (c) booting the computer from the recovery partition to execute the small operating system and the recovery utility program in the recovery partition of the computer as to create and format a user partition on the local hard disk drive after the execution, and recovering the compressed operating system/application program/user data in the recovery partition to the user partition; (d) booting the computer from the local hard disk drive, such that the computer is selected to enter into the user partition to execute the computer operating system/application program/user data or the computer is selected to enter into the recovery partition to execute the recovery utility program, and then restore the compressed operating system/application program/user data to the user partition, wherein users are allowed to choose whether or not to save the current existing data of the user partition when recovering the user partition.

### FIELD OF THE INVENTION

The present invention relates to a method for recovering an operating system and user data executed in a computer and its recovery system, more particularly to a method for recovering an operating system and its installed application programs without actively destroying the existing data during the recovery process.

### BACKGROUND OF THE INVENTION

In general, it is necessary to reinstall the operating system and all application programs if there is a failure and users cannot solve such problem on their own. The operation of this sort wastes time and effort, and sometimes the discs of the operating system and application programs may not be at hand for an immediate installation. Therefore, some system recovery utility programs are developed for users and give a more convenient way to recover the system. However, the prior-art system recovery utility program can only recover the partition of a hard disk drive. In other words, these system recovery utility programs overwrite the entire partition according to the mapped files of the hard disk drive or overwrite the entire hard disk drive according to the mapped files of the hard disk drive. The original existing data will be cleared after the entire partition or the entire hard disk drive is overwritten. The prior-art system recovery utility program cannot avoid such problem. For example, all user setups are erased when overwriting the partition or the hard disk drive. Although such arrangement can avoid the trouble of reinstalling all application programs, yet it is necessary to reinstall all self-defined options. As a matter of fact, most computer users are not professional engineers or computer experts, and such recovery task bothers many general users.

In view of the shortcomings of the prior art, the inventor of the present invention invented a method for recovering an operating system and user data executed in a computer and its recovery system. By storing a backup copy of data in another recovery partition, the recovery utility program of the invention is called to safely restore the whole operating system, application program and user data when the system fails. The whole process is highly automatic and requires very little manual operation, and thus the invention can save time and effort. In the meantime, the original system setup will not be erased, which can definitely eliminate the trouble of non-professional users at home.

### SUMMARY OF THE INVENTION

The primary objective of the present invention is to provide a method for recovering operating system data and user data executed in a computer and its recovery system by backing up data in the user's partition, automatically completing the recovery process when it is necessary to restore the data stored in a recovery partition and separated from the user data.

The second objective of the present invention is to provide a method for recovering operating system data and user data executed in a computer and its recovery system, wherein the backup data and the recovery utility program are stored in a recovery partition and separated from the user data.

The third objective of the present invention is to provide a method for recovering operating system data and user data and its recovery system, wherein a predetermined press key on the keyboard is used to start the operation of the recovery.

The fourth objective of the present invention is to provide a method for recovering operating system data and user data executed in a computer and its recovery system, wherein the backup files are saved in the form of compressed files and the data recovery is proceeded by decompressing these files.

The fifth objective of the present invention is to provide a method for recovering operating system data and user data executed in a computer and its recovery system, wherein the recovery is started with an optical disc for the first time, and it no longer needs such optical disc for recovering the system data thereafter.

To achieve the foregoing objectives, the present invention provides a method for recovering the operating system and user data executed in a computer and its recovery system, which comprises the steps of: (a) preparing an optical disc which comprises: a small operating system, a recovery utility program, and a recovered computer operating system/application program/user data; (b) starting the optical disc to run the small operating system and the recovery utility program in the computer, creating a recovery partition on a local hard disk drive of the computer after the execution, formatting the recovery partition, copying the small operating system, recovery utility program, pre-compressed operating system/application program/user data to the recovery partition, and setting the recovery partition as the booting partition; (c) booting the computer from the recovery partition to execute the small operating system and the recovery utility program in the recovery partition of the computer so as to create a user partition in the local hard disk drive after the execution, and format the user partition, and recover the compressed operating system/application program/user data in the recovery partition to the user partition; (d) booting the computer from the local hard disk drive, such that the computer is selected to enter into the user partition to execute the computer operating system/application program/user data or the computer is selected to enter into the recovery partition to execute the recovery utility program, and then restore the compressed operating system/application program/user data to the user partition, wherein users are allowed to choose whether or not to save the current existing data of the user partition when recovering the user partition.

Further, to achieve the foregoing objectives, the present invention provides a method for recovering the operating system and user data executed in a computer and its recovery system, which comprises: at least one local hard disk drive of the computer, an optical disc (referring to one or more optical discs, but not particularly limited to one disc) which stores a small operating system, a recovery utility program, and a recovered computer operating system/application program/user data; wherein the optical disc is run by booting the computer to execute the aforementioned recovery method.

### BRIEF DESCRIPTION OF THE DRAWINGS

The detailed description and technical characteristics of the present invention are described together with the drawings as follows:

FIG. 1 is a flow chart of the present invention;

FIG. 2 is a view of the data structure of the optical disc according to the present invention;

FIG. 3 is a view of the hardware for executing the recovery method according to the present invention;

FIG. 4 is a view of the screen showing the execution of the recovery utility program according to the present invention; and

FIG. 5 is a flow chart of step 107 according to the present invention.

### DETAILED DESCRIPTION OF THE INVENTION

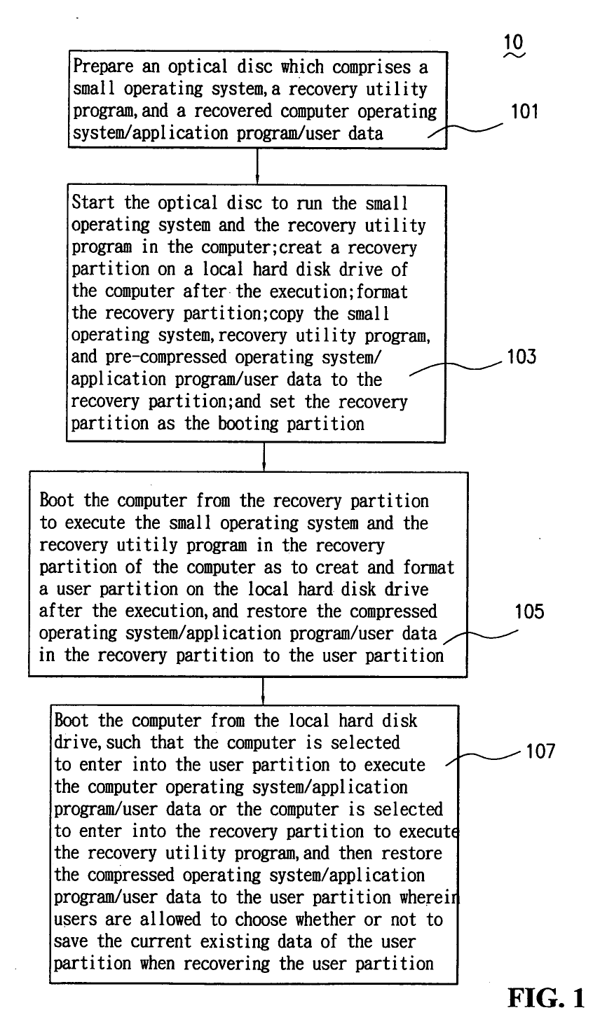

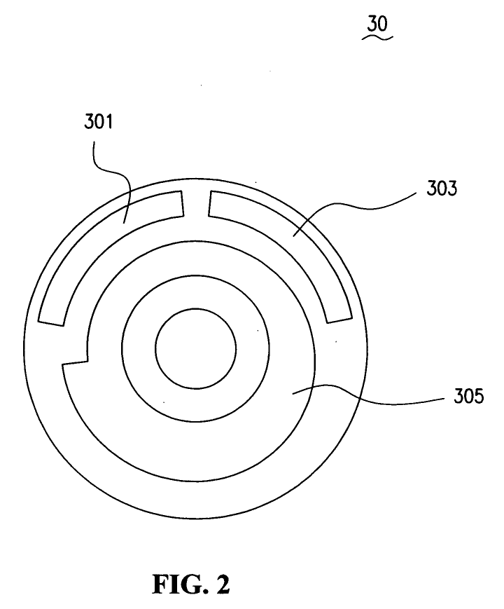

Please refer to FIG. 1 for the flow chart of the method according to the present invention. The method 10 for recovering an operating system and user data executed in a computer comprises Steps 101, 103, 105, and 107 as described below. Step 101 is to prepare an optical disc 30 which stores a small operating system 301, a recovery utility program 303, and an operating system/application program/user data 305 of a restored computer 40. Please refer to FIG. 2 for the data structure of the optical disc 30 according to the present invention. To successfully proceed with the method according to the present invention 10, an optical disc 30 is used to store various software or data required for the recovery. Such arrangement brings tremendous convenience to general users who install a brand new operating system/application program/user data 305 into a computer or reinstall an operating system/application program/user data 305 when the computer is damaged. The quantity of optical discs 30 produced after Step 101 ends is not limited to one, but depends on the total number of the small operating system 301, recovery utility program 303, and operating system/application program/user data 305.

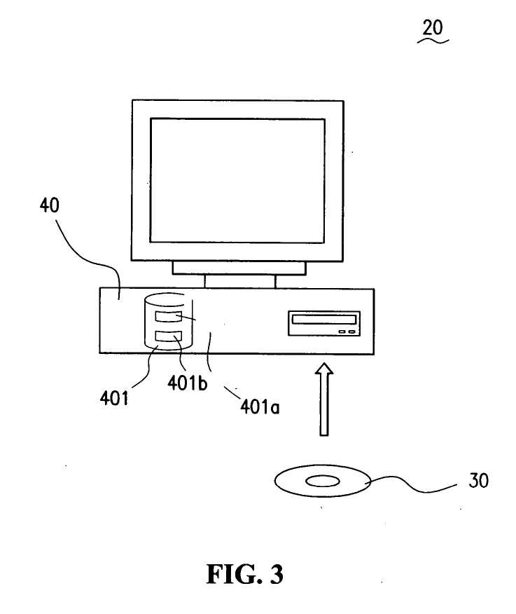

Please refer to FIG. 3 for the view of the hardware for executing the method according to the present invention. Step 103 is to start the optical disc 30 and let the computer 40 run the small operating system 301 and the recovery utility program 303 on the optical disc 30, and then a recovery partition 401a is created on a local hard disk drive 401 of the computer 40 after the execution is completed. The recovery partition 401a is formatted, and the small operating system 301, the recovery utility program 303, and the compressed operating system/application program/user data 305 are copied onto the recovery partition 401a, and then the recovery partition 401a is set as the booting partition. In Step 103, the computer 40 boots directly from the optical disc 30 and the booted computer 40 works under the environment of the small operating system 301 and automatically runs the recovery utility program 303 to create a recovery partition 401a, and formats the recovery partition 401a. The small operating system 301, the recovery utility program 303, and the pre-compressed operating system/application program/user data 305 are copied onto the recovery partition 401a and the master boot record (MBR) 401 is modified, so that the recovery partition 401a becomes the booting partition. After Step 103 is completed, users can remove the optical disc 30 from the computer 40.

Step 105 is to boot the computer 40 from the recovery partition 401a, and the computer 40 runs the small operating system 301 and recovery utility program 303 in the recovery partition 401a, so that a user partition 401b is created on the local hard disk drive 401 after the execution is completed. Then, the user partition 401b is formatted, and the compressed operating system/application program/user data 305 in the recovery partition 401a are restored to the user partition 40 lb.

In Step 105, the computer 40 boots from the recovery partition 401a, and then the computer 40 also works under the environment of the small operating system 301, and automatically runs the recovery utility program 303. By executing the recovery partition program 303, the user partition 401b is created and formatted. Then, the operating system/application program/user data 305 stored in the recovery partition 401a are decompressed. All decompressed data are then stored into the user partition 401b, and then the master boot record (MBR) of the local hard disk drive 401 is modified, such that the user partition 401b is set as the booting partition. With the optical disc 30 according to the invention, Steps 103 and 105 are used to install a brand new computer quickly with an effect similar to copying data from a virtual hard disk drive, and also creates a recovery partition 401a to be used in future recoveries.

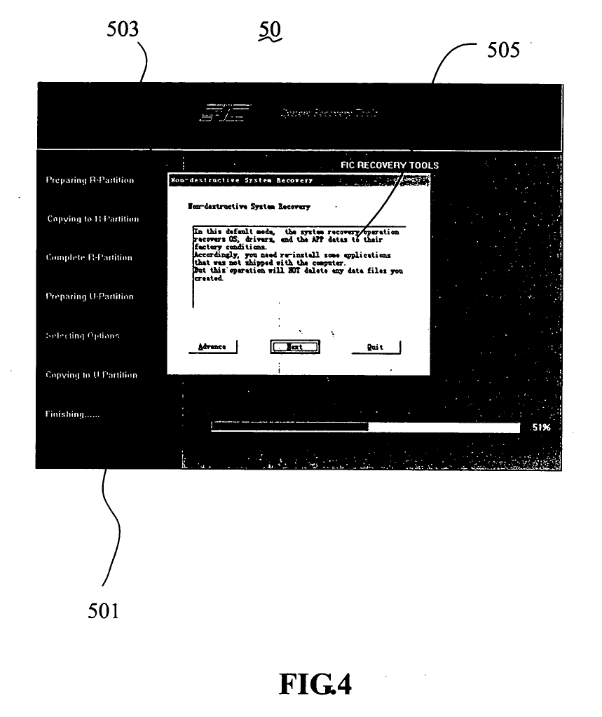

After Steps 103 and 105 are implemented, the screen displayed on the computer 40 is shown in FIG. 4, and the screen 50 is used for showing the current operating status of the recovery utility program 303. If the displayed text 501 shows that the recovery utility program 303 is in an operating status, then the text is highlighted. If the displayed text 501 shows that the recovery utility program 303 is not in an operating status, then the displayed text 503 remains unchanged. The menu interface 505 is a man-machine interface for showing users how to proceed with the operation.

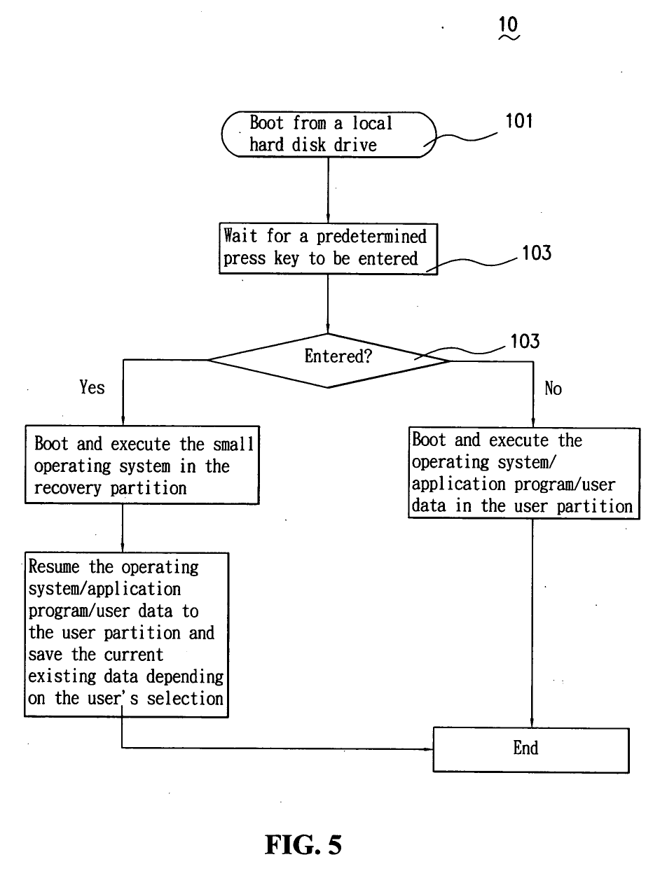

Step 107 is to boot the computer 40 from the hard disk drive 401, so that the computer 40 selects to enter directly into the user partition 401b and run the operating system/application program/user data 305 or selects to enter into the recovery partition 401a and run the recovery utility program 303. Please refer to FIG. 5 for the flow chart of Step 107 according to the invention. When the computer 40 boots from the hard disk drive 401, the computer 40 immediately detects whether or not a predetermined press key is pressed; if it is true, then the decompressed operating system/application program/user data 305 in the recovery partition 401a are restored to the user partition 401b, so that when the user partition 401b is recovered, users are allowed to select whether or not to keep the current existing data in the user partition 401b; if it is false, then the system enters directly into the user partition 401b to run the operating system/application program/user data 305 in the user partition 401b. Step 107 of the present invention allows users to select whether or not to proceed with the recovery of an operating computer 40 anytime. If the operating computer 40 is damaged, then users have to select to recover the computer. In the recovery process, it is noteworthy that Step 107 according to the invention allows users to select whether or not to keep the current existing data in the user partition 401b, so that users do not have to worry about the existing important data in the local hard disk drive 401 being erased at all.

Please refer to FIG. 3 for the spirit and theory for implementing a recovery system 20 according to the recovery method 10 of the invention. Undoubtedly, the recovery method 10 of the invention can be implemented by software.

The abovementioned small operating system adopted by the invention refers to the Microsoft Windows PE operating system, and the abovementioned operating system adopted by the invention refers to a Microsoft Windows operating system, such as Windows XP and Windows 2000 etc.

While the invention has been described by way of example and in terms of a preferred embodiment, it is to be understood that the invention is not limited thereto. To the contrary, it is intended to cover various modifications and similar arrangements and procedures, and the scope of the appended claims therefore should be according to the broadest interpretation so as to encompass all such modifications and similar arrangements and procedures.

What is claimed is:

1. A method for recovering the operating system and user data executed on the computer, comprising the steps of:
(a) preparing an optical disc, and said optical disc comprises a small operating system, a recovery utility program, and a recovered computer operating system/application program/user data;
(b) starting said optical disc to run said small operating system and recovery utility program in a computer, creating a recovery partition on a local hard disk drive of said computer after the execution, formatting said recovery partition, copying said small operating system, recovery utility program, pre-compressed operating system/application program/user data to said recovery partition, and setting said recovery partition as a booting partition;
(c) booting said computer from said recovery partition to execute said small operating system and recovery utility program in said recovery partition of said computer as to create and format a user partition on said local hard disk drive after the execution, and recovering said compressed operating system/application program/user data in said recovery partition to said user partition; and
(d) booting said computer from said local hard disk drive, such that said computer enters selectively into said user partition to execute said computer operating system/application program/user data and said computer enter selectively into said recovery partition to execute said recovery utility program, and then recover said compressed operating system/application program/user data to said user partition, wherein users are allowed to selectively save the current existing data of said user partition when recovering said user partition.

2. The recovery method of claim 1, wherein said small operating system is Microsoft Windows PE operating system.

3. The recovery method of claim 1, wherein said operating system is Microsoft Windows operating system.

4. The recovery method of claim 1, wherein said computer is an IBM compatible personal computer.

5. A recovery system for recovering operating system and user data executed in computer, comprising:
a computer, having a local hard disk drive;
an optical disc, having a small operating system, a recovery utility program, an operating system/application program/user data of a recovered computer; wherein said computer boots from optical disc to execute the steps of:
(a) executing said small operating system and recovery utility program of said optical disc, and creating a recovery partition on a local hard disk drive of said computer after the execution, formatting said recovery partition, copying said small operating system, recovery utility program, pre-compressed operating system/application program/user data to said recovery partition, and setting said recovery partition as a booting partition;
(b) booting said computer from said recovery partition to execute said small operating system and recovery utility program in said recovery partition of said computer so as to create and format a user partition on said local hard disk drive after the execution, and recovering said compressed operating system/application program/user data in said recovery partition to said user partition; and
(c) booting said computer from said local hard disk drive, such that said computer enters selectively into said user partition to execute said computer operating system/application program/user data and said recovery partition to execute said recovery utility program, and then recover said compressed operating system/application program/user data to said user partition, wherein users are allowed to selectively save current existing data of said user partition when recovering said user partition.

6. The recovery system of claim 5, wherein said small operating system is Microsoft Windows PE operating system.

7. The recovery system of claim 5, wherein said operating system is Microsoft Windows operating system.

8. The recovery system of claim 5, wherein said computer is an IBM compatible personal computer.
